(19) United States
(12) Patent Application Publication
(10) Pub. No.: US 2007/0212531 A1
(43) Pub. Date: Sep. 13, 2007

(54) Process for recycling fiber material and binder with novel injection mold and parts made thereby

(76) Inventors: Dan McIntyre, Carrollton, TX (US); Gary Carpenter, Carrollton, TX (US); Robbie Rex Powell, Bonham, TX (US)

Correspondence Address: George R. Schultz;Schultz & Associates, P.C., One Lincoln Centre, 5400 LBJ Freeway, Suite 1200, Dallas, TX, 75240, US

(21) Appl. No.: 11/369,595

(22) Filed: Mar. 7, 2006

(51) Int. Cl. B29C 47/96; B32B 27/04; H05B 6/00

(52) U.S. Cl. 428/297.4; 264/478; 425/149

(57) ABSTRACT

A process of recycling fibrous materials, specifically carpet and diaper remnants, or high melting polymers, specifically PET, by using low melting polymers, i.e. agricultural film and other products made from polypropylene and polyethylene, to create parts of high compressive strength. The carpet, fibrous materials, or PET and low melting polymers are ground separately and then blended in a predetermined ratio. The blend is then sent through a pellet mill and then heated until the low melt polymer is melted, or approximately 450° F. The melted mixture is then injected into a partially opened cavity mold, which is then closed without allowing the excess material to escape. Closing the mold increases the internal pressure on the molten material. The cavity mold is then rapidly cooled.

### FIELD OF THE INVENTION

The present embodiments relate to a method for recycling fibrous materials and binders into parts of high compressive strength.

### BACKGROUND

The invention relates to the making of high compressive strength plastic parts through the process of grinding and mixing waste material such as fibrous materials, specifically carpet, diaper remnants and other high melt plastics with binders, such as agricultural films creating a molten material by heating and mixing the waste materials and injecting it into a novel injection cavity mold and compressing it with a hydraulic cylinder. The preferred products made by the process includes parts capable of withstanding high compressive forces. For example, parts used in the construction industry and packaging industry.

The environmental impact of waste products and recycling of waste products has been a significant concern and continues to be so as landfill space decreases. Some materials that create significant problems are carpets, scrap material from diaper production, and both low melt and high melt polymer products, such as agricultural films, and plastic bottles.

Agricultural film is used to contain hay silage and other agricultural products in bales for storage and shipment. Agricultural film is also used in growing and harvesting fruit from low-lying plants, such as strawberries. The agricultural film is placed between the ground and the mulch surrounding the plants. When the agricultural film is removed it is often discarded.

Carpets present unique disposal problems because they are made of different types of synthetic materials and have different types of backing materials. Further, due to the bulk and the tendency of carpet to absorb moisture, carpet takes up significant amount of space in landfills and presents significant problems in transportation.

Traditionally, one difficulty with disposing of carpeting is the fact that carpet typically is manufactured with multiple layers and differing types of synthetic fibers, each having different physical and chemical properties. For example, the simplest types of carpets might have fibrous pile (e.g. nylon, PET, or polypropylene) fused directly to a thermoplastic, typically polyolefin, backing. There can also be a secondary fiber material or substrate layer, a reinforcing web material through which the pile is attached, and/or separate glue that is used to anchor the pile to the backing.

The carpet can comprise any available main material (e.g., poly(ethylene terephthalate) (PET), polypropylene, nylon carpet, and the like), with any pile weight. The carpet may be in any number of physical conditions including soiled, wet, dyed, treated for stain resistance, and the like, as well as combinations comprising at least one of the foregoing conditions. Preferably a post-consumer or used carpet is employed for reasons of economy, availability, and environmental considerations; although, non-used carpet, such as carpet unacceptable for sale, trim scrap from production of the carpet, or carpet returned by the purchaser, may also be used. Preferably, for shipping economy, space, and the like, the carpet is in the form of bales or gaylords that can comprise any number of different types of PET, polypropylene, or nylon carpets, e.g., different carpet origins, physical properties, chemical properties, and the like. Unlike many carpet recycling methods, the carpet can be unseparated, i.e., carpet that has not been modified to remove or separate out one or more of the primary components (pile, backing, adhesive, etc.) from the carpet prior to processing. Although an unseparated bulk carpet sample is preferred, separated carpet, or portions thereof can be employed in the present process.

Typically, the carpet will comprise pile, a backing, an adhesive, and a filler. The pile and the backing often comprises a thermoplastic material, such as a polyolefin, polyester, polypropylene, nylon, and the like, as well as combinations comprising at least one of the foregoing materials. The adhesive typically employed to adhere the pile to the backing typically comprises a latex material, other adhesives, and the like. Some possible adhesives include styrene-butadiene rubber (SBR), acrylate resins, polyvinyl acetate, and the like, as well as combinations comprising at least one of the foregoing adhesives. Finally, the filler comprises calcium carbonate.

Typically, a carpet can comprise a main material and optionally, latex, flame retardants, additives, and the like. Generally, the carpet comprises greater than or equal to about 50 weight percent (wt %) of the main material (e.g., PET, polypropylene, nylon, or the like), with greater than or equal to about 70 wt % main material preferred, and greater than or equal to about 80 wt % main material more preferred, based on the total weight of the carpet excluding water weight. The carpet typically also comprises greater than or equal to about 5 wt % latex material, may comprise up to about 20 wt % or so of a flame retardant, and may comprise about 0.5 wt % to about 10 wt % calcium carbonate. In an exemplary embodiment, a carpet comprises, about 80 wt % to about 85 wt % main material (e.g., PET, polypropylene, nylon, or the like), about 10 wt % to about 15 wt % latex material, and less than or equal to about 10 wt % calcium carbonate, based on the total weight of the carpet excluding water weight.

The carpet may include non-woven bonded fabrics are sometimes also called “composite textiles.” They are seen as textile fabric consisting of fiber mats held together because of their inherent bonding properties or as a result of a mechanical process involving the use of a chemical bonding agent. Their properties depend on what they are going to be used for and are expressed in the form of physical and chemical characteristics.

Tufted carpets are composite structures in which the yarn that forms the pile (the surface of the carpet) typically nylon 6 or nylon 6,6, polypropylene, polyester as set forth in further detail below, is needled through a base or backing fabric such as a spun bonded polyester. The base of each tuft extends through this backing fabric and is visible on the bottom surface of the composite structure. Tufted carpets are generally of two types, nap and shag.

In nap carpets, yarn loops are formed by needling or punching a continuous yarn just through the base fabric, thus forming the base of the carpet, while the tops of the loops are generally ¼ to ¾ inch long, thus forming the wearing surface of the carpet.

Shag carpets have the same base as the nap carpet but the tops of the loops have been split or the tips of the loops have been cut off. The surface of the shag carpet is thus formed by the open ends of the numerous U-shaped pieces of yarn, the base of the U being embedded in the base fabric.

The loops of yarn are needled through and embedded in the backing (the combination of which is the raw tufted carpet), thus forming the tufted base, which must be secured to the base fabric to prevent the loops from being pulled out of the base fabric. The tufted bases are generally secured by applying a coating compound known as a precoat to the back of the raw tufted carpet to bond the tufted yarns to the base fabric. This is generally polyethylene or poly(ethylene-co-vinyl acetate). A secondary backing material known as a mass coat usually is also applied to the back of the raw tufted carpet and bonded to it with the same pre-coat adhesive that secures the yarn to the base fabric.

The mass coat can be heavily filled or unfilled, polyethylene or ethylene-vinyl acetate copolymer. The application of the secondary backing material further secures the loops of yarn since they are then bonded by the adhesive to the backing material as wall as the base fabric.

The base fabric or primary backing may be of any type known in the art and may be non-woven polymer fabric. Likewise, the secondary backing material may also be non-woven polymer fabrics. The aforementioned backings are formed from materials such as needle-punched, woven or non-woven polypropylene and non-woven polyester webs and fabrics and blends thereof.

The ethylene-vinyl acetate copolymer backing material consists of a low melting point thermoplastic material, sometimes filled with inorganic particulate fillers such as calcium carbonate or barium sulfate. The fiber portions of the carpet are produced from materials such as polypropylene, nylon 6, or nylon 6,6, and polyethylene terephthalate (PET).

Mixed recycling is a possible approach for this composite product, however, there can be problems with compatibility of the various materials that make up the carpet. Although a considerable effort has been undertaken regarding the improvement of compatibility of immiscible polymer blends related to the recycling of mixed plastic waste, very few studies have been reported on the secondary of carpet scrap.

The yarn used in forming the pile of a tufted carpet can be made of any type of fiber known in the art to be useful for tufted carpets, e.g., nylon, acrylics, wool, cotton, and the like. In North America, nylon 6 and nylon 6,6 are the most commonly used fiber material for tufted carpet. In Europe and Japan, polypropylene is the most common auto full floor carpet material (tufted and nonwoven). While blends of nylons and polypropylene are generally not directly compatible, it has been determined that compatibilizing additives such as carboxyl containing ethylene copolymers can improve the mixed recycling of polypropylene blends.

This is particularly pertinent in the nylon/polypropylene carpet recycling since copolymer materials such as ethylene/vinyl acetate (EVA) are commonly used in back-coating of the carpet composition. These back coatings are usually applied in the form of a latex or an extruded “hot melt.” The carpet is then either heated to cure the latex, or allowed to cool to solidify the hot melt. It has been discovered that the recyclability of the carpet is improved if a compatibilizing additive, such as a ethylene-vinyl acetate copolymer, is used as a functional component by addition to the carpet formulation.

Disposable diapers can also be used in the method of the invention. The modern disposable diaper contains multiple layers of material depending on a manufacturers design. Inner layers in contact with the infants skin are made of textured polypropylene as are the other fibrous layers such as a transfer sheet and back sheet cover. The inner layer contains a cellulose and super absorbent material such as polyacrylate, super absorbent gels or vinyl monomers.

Agricultural film, agricultural bags and silage bags can also be recycled by the process of the invention. Typically agricultural film is made of polyvinyl chloride and polyethylene sometimes including carbon, titanium or metallic coatings to obtain various colors and textures of the film for various usages.

Various processes exist in the art to recycle carpet and agricultural film, however none has been entirely successful at producing parts significant or high compressive strength.

For example, United States publication no. 2003/0075824 A1 to Moore, Jr. et al. entitled “Method for Recycling Carpet and Articles Made Therefrom” discloses a method for recycling carpet and for making articles with the recycled carpet including melting the recycled carpet, reducing a water content of the recycled carpet, forming a melt ribbon and forming pellets from the extruded melt ribbon of the recycled carpet. The method further discloses using injection molding, bowl molding, and extrusion to form articles. However, Moore does not disclose the advantage of using a low pressure extruder combined with a compression cavity mold to form the parts of high compressive strength.

Another example is U.S. Pat. No. 6,253,527 to De Zen. De Zen discloses composite products comprising or incorporating compression moldings of waste or filler particles encapsulated and bound together by a thermal plastic fiber material into a compacted mass. The method discloses intensely mixing particles of thermoplastic and waste filler to raise their temperature to bring the thermoplastic particle to a molten state and then molding the materials under pressure. However, De Zen does not disclose a method suitable for preventing escape of molten material from the mold during the compression process thereby limiting the maximum compression which can be used to form the part.

Another example is U.S. Pat. No. 5,075,057 to Hoedl. Hoedl discloses recycling scrap plastic materials including thermoplastic incurred thermo setting components and molding them into products of a predetermined shape without the necessity of separating the different plastics from one another by process of shredding and milling the mixture to reduce it to fine particles, homogenizing the fine particles into a free flowing powder, warming the homogenized mixture to an elevated temperature, dry blending the warm mixture with a reinforcing material or filler and then using a double belt press to compress the mixture into flat panels. The process disclosed by Hoedl does not solve the problem of preventing the escape of the heated mixture from the compression process during the compression step and therefore limits the compression available and the compressive strength of the part created.

Many types of plastic parts require high compressive strength. For example, when transporting large household appliances, packing material must have certain limits of structural integrity and other important characteristics. The packing material must have sufficient structural integrity to hold its shape and structure during the transportation and handling of the appliance prior to final installation. This includes the ability to withstand compression forces created from the stacking of similar appliances during storage. In the prior art, the stacking of appliances on storage has been limited by the compressive strength of the corner posts contained in the packages. However, with the advent of large wholesale chains requiring large distribution containers, a great need for vertical stacking and storage exists which has not been addressed by the prior art packaging available. The packaging must also be able to absorb the energy from impacts with other items, such as unintended an impact by other appliances or equipment prior to final installation, so that the packed appliance is not damaged. Also, since a certain amount of shear force is applied to the packaging during the handling of the packaged appliance prior to installation, the packing material must have sufficient shear strength to maintain its shape and protect the appliance inside.

The capabilities of prior art corner posts are limited. For example, a prior art corner post made from prior art injection techniques demonstrates a compressive strength of between 210-220 psi which allows for stacking densities of only 3-5. In the prior art, packing materials are also constructed of wood or corrugated cardboard. The prior art materials of the prior art are necessarily therefore flammable, biodegradable, subject to degradation by moisture and infestation by rodents. Additionally, the materials used in the prior art are relatively heavy and add to total package weight. Moreover the compressive strength of these “natural” materials is no greater than 200-250 psi which is also unsatisfactory for acceptable stacking densities.

Another example of parts requiring high compressive strength include building materials such as vertical wall columns and studs. Vertical wall columns and studs in the building industry for interior and exterior use often require high compressive strength. Moreover, specifically in the areas of prefabricated housing light weight and high compressive strength is necessary combination for structural integrity of the building strength.

Other areas of use of low weight high compressive strength parts is the automotive industry. Fenders, shock absorbing connectors and exterior body parts all necessarily require high compressive strength and can be made by the preferred embodiment of the method of this invention.

Another fruitful area for use of high compressive plastic parts is the area of security barriers for the prevention of vehicle intrusion around buildings and areas of high security. Additionally, high compressive strength is effective in preventing blast penetration from explosives as well as preventing intrusion by vehicle impact. Similar areas include highway barriers and structures for preventing accidents along bridges, roadways and support columns for bridges and overpasses. All require plastics of low weight but high structural integrity which can be formed from the process of the invention disclosed.

### BRIEF SUMMARY OF THE INVENTION

In general, the preferred embodiment of the invention is directed to manufacturing high compressive strength parts such as packaging materials, columns and pallets by the use of recycled carpet, fibrous materials, and/or high melt polymers mixed with binders.

The preferred embodiment of the method involves grinding the materials to be recycled to a controlled size by the use of the appropriately sized grinding screens. Upon grinding, the chosen materials are blended in a pre-determined ratio and thereafter, pelletized. The pellets maintain the predetermined blend ration and form an appropriate combination of fiber material and binder powder and increase the bulk density. The blended materials are heated to a controlled temperature such that the binder material is melted but melting of the fiber is prevented. The molten material is then injected at low pressure into a novel cavity mold which allows for extremely high compressive forces to be exerted during the molding process.

The cavity mold is designed with two halves that, when assembled, form a cavity specific to the particular part being manufactured. The cavity mold of the invention is designed with a novel interlocking tortuous path seal to reduce the flow of molten material out of the cavity mold.

Historically, the two cavity mold halves are closed completely during the injection process. However, in the method of a preferred embodiment of the invention, the cavity mold halves are not closed completely, but instead are only closed partially during injection of the molten material. During molding the cavity mold is overfilled with molten material and then closed by a high strength hydraulic cylinder. The molten material is prevented from escaping from the cavity mold due to the interlocking tortuous seal. Closing the cavity mold generates compression of the polymer and high structural density. The heat generated from the compression drives off excess water and sterilized the part. The novel cavity mold is also provided with an oversized water jacket which enables the mold and the part contained to be rapidly cooled. Rapid cooling “freezes” fibers in place in a molten matrix which also increases compressive strength.

### BRIEF DESCRIPTION OF THE DRAWINGS

In the detailed description of the preferred embodiments presented below, reference is made to the accompanying drawings.

FIG. 1 is a perspective view of a packing frame utilizing a preferred embodiment of a part made through the method of the invention.

FIG. 2 is a schematic diagram of the steps of a preferred embodiment of the method of the recycling process.

FIG. 3 is a schematic section view of a prior art injection cylinder.

FIG. 4 is a schematic view of a prior art injection molding machine, cavity mold, controller and hydraulic system.

FIG. 5 is a section view of a preferred embodiment a cavity mold of the invention in place in a molding machine.

FIG. 6A is a section view of a tortuous path seal of a preferred embodiment of the cavity mold of the current invention.

FIG. 6B is a plan view of the face of a mold of the preferred embodiment of the invention with a tortuous path seal.

FIG. 6C shows a section view of an alternate embodiment of the tortuous path seal of the invention where the mold is partially open.

FIG. 6D shows a section view of an alternate embodiment of the tortuous path seal of the invention where the mold is closed.

FIG. 7 is a plan view of a preferred embodiment of a high compression packing post made by the method of the current invention.

FIGS. 8A & 8B are elevation views of a preferred embodiment of a high compression packing post produced by the current invention

FIG. 9 is a listing of program pseudo code for a controller performing one preferred embodiment of the method of the invention.

### DETAILED DESCRIPTION OF THE PREFERRED EMBODIMENTS

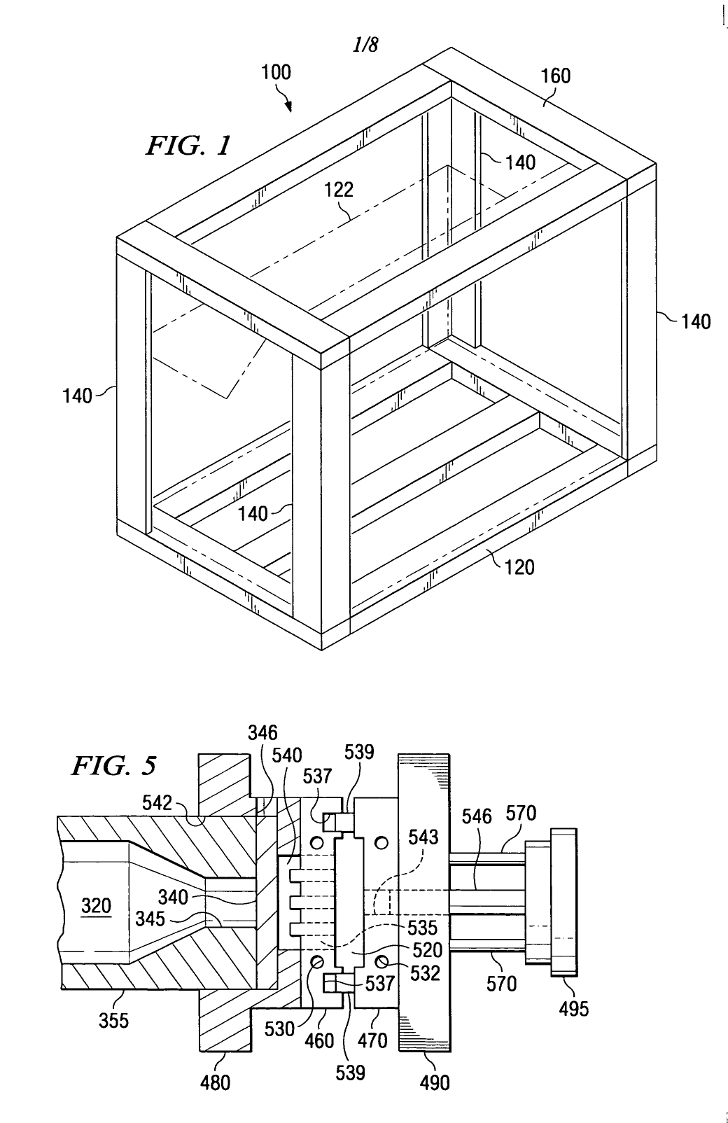

FIG. 1 illustrates a packaging structure 100 including corner posts 140, pallet 120 and upper support frame 160. Pallet 120 is affixed to appliance 122 (shown ghosted) through a means of bolts or screws inserted from the bottom of the pallet into the bottom of the appliance. Corner posts 140 are either rigidly affixed to pallet 120 or inserted into slots into pallet 120 and are typically banded to appliance 122 after manufacture of the appliance. Upper support frame 160 is rigidly affixed to the top of each of support angles 140 typically through an epoxy adhesive or inductive heat welding. Typically, a cardboard box is placed around a packaging structure 100 prior to shipment or storage.

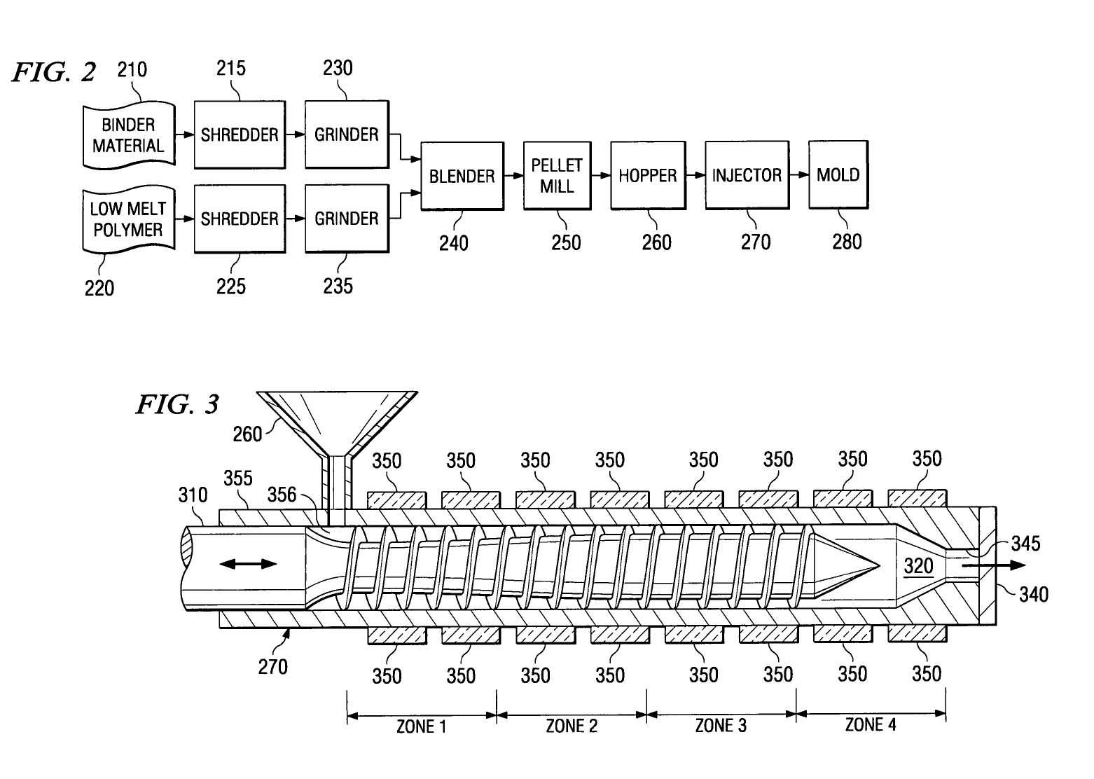

FIG. 2 depicts the steps of the method of the preferred embodiment used to recycle plastic and fibrous materials into packing parts. Gaylords of carpet or other fibrous fiber material 210 are fed into a shredder 215. The shredder 215 shreds the fiber material 210 into pieces of approximately 1″ to 2″ square. However, those skilled in the art will recognize that the size of the pieces is dependant on the grinder chosen to carry out the method. The fiber material may be washed or cleaned and disinfected prior to being sent to the shredder 215, but this is not required. Importantly, the invention does not require removal of water from the carpet material for use.

The pieces are then transferred by conveyor into grinder 230. Grinder 230 grinds the pieces into short lengths. The average length of the fiber material fibers resulting is between ¼″ and ⅛″. Longer or shorter fiber lengths are acceptable and dependent on the grinder chosen. In the preferred embodiment, grinder 230 uses a ¼″ screen to obtain the proper fiber length, however, other screen sizes that yield the above described average fiber length are acceptable.

Binder 220 is fed into shredder 225. Binder 220 in the preferred embodiment has a melting temperature at or below 450° F. Examples of such binders are agricultural film, blow molded plastic containers, and other post-consumer articles made of polyethylene and polypropylene.

Gaylords of binder 220 are sent to shredder 225. The shredder shreds binder 220 into pieces of an average size of 1″ or 2″, with the pieces typically not being larger than 3″ square in the preferred embodiment. The binder may be washed or cleaned and disinfected prior to being sent to shredder 215, but this is not required. The pieces are transferred by conveyor or other means to grinder 235. Grinder 235 grinds the pieces to a size of approximately ½″ or less. In the preferred embodiment, grinder 235 uses a ⅜″ to ½″ screen to reach this desired size. However other commercially available grinding means or other screen sizes that allow for the same average size of ground material can be used without departing from the spirit of the invention.

After both the fiber material and binder are ground, they are blended in blender 240 at a predetermined ratio, based on the specific properties needed for the final product. The predetermined ratio in the preferred embodiment is approximately 60% fiber material to approximately 40% binder based on weight. The percentages may vary up to 10% per component in a preferred embodiment.

Other fibrous materials, such as remnants from diaper manufacturing, or high melt polymers can also be added to blender 240 based on the availability of materials and the specific characteristics needed for the final product. In one embodiment, diaper remnants are added at a predetermined approximate ratio of 40% diapers remnants, 40% carpet, and 20% agricultural film by weight. The percentages may vary up to 5% per component in a preferred embodiment.

After the materials are blended, they are transferred to pellet mill 250 for pellitization by conveyor system. The blend ratio from blender 240 is maintained and the bulk density is increased. The pellet size should be in the range of ⅛″ to ¼″ in diameter and maximum length of 1″. However, in the preferred embodiment, the pellets that result from pellet mill 240 are approximately ⅜″ in length and ⅛″ in diameter.

The pellets are sent to hopper 260. In one embodiment, hopper 260 contains a dryer for removing the surface moisture from the pellets. The dryer pumps heated air into the bottom of hopper 260 which flows through the pellets as it rises. The temperature of the air should be approximately 200° F. However, the temperature of the air must not exceed the melting temperature of the binder. Further, though not required, the air can be fed through a dehumidifier prior to being sent to hopper 260. Drying is not required for the invention to function satisfactory.

After leaving hopper 260, the pellets are fed into injector 270 where they are mixed and heated to a maximum of 450° F. through a series of heated zones and the mechanical action of the injector. The binder is melted during heating but the fiber material is not.

The melted polymer material is then injected into cavity mold 280 in which the part is formed.

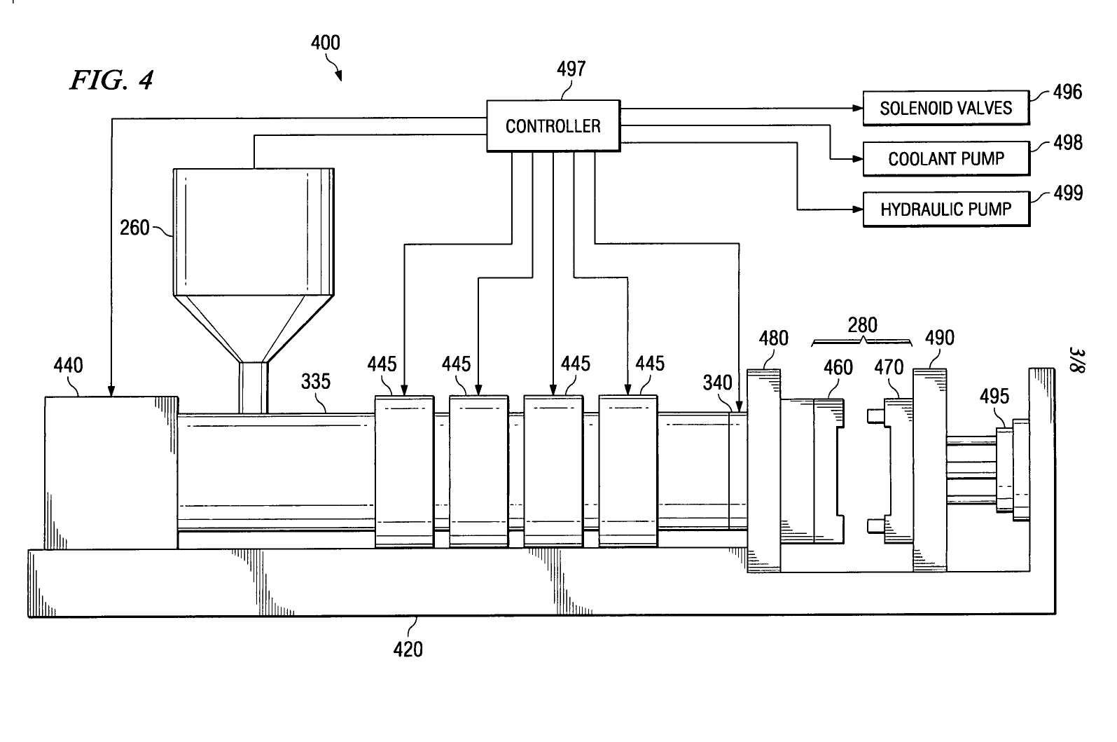

Referring to FIGS. 3 and 4, is a schematic diagram of injector system 400 can be seen. Injector system 400 comprises a stationary frame 420 supporting a number of components. Motor box 440, supported by supporting frame 420, is connected an axial shaft of helical screw 310. Motor box 420 provides rotational and axial forces to helical screw 310 during operation of the system. Helical screw 310 resides in injection cylinder 355. Hopper 260 is ductedly connected to the injection cylinder allowing access for pelletized material to feed chamber 356. Stationary frame 420 also supports casings 445 in which are housed heating elements 350. Stationary frame 420 also supports platen 480 and platen 490 which form supports for cavity mold halves 460 and 470, respectively. Platen 490 is axially movable through hydraulically driven cavity mold clamp 495, also supported by stationary frame 420.

System 400 also includes an electronic controller 497. Electronic-controller 497 of the preferred embodiment is a programmable logic controller capable of stepwise execution of programmed instructions. Electronic controller 497 is connected to functions of the command of rotational and axial functions of motor box 440, the activation and control of heating elements 350, the activation and control of nozzle gate 340, the activation and temperature control of coolant pump 498, the activation of hydraulic pump 499 and the activation and control of solenoid valves 496. Solenoid valves 496 control the flow of hydraulic fluid to cavity mold half 495 and the rotational and axial drives of motor box 440.

Electronic controller 497 is also responsible for activating the function of hopper 260 including the temperature and activation of air circulation within the hopper under the activation of the hopper gate which controls dispensing the contents of the hopper into the feed chamber of the injection cylinder.

FIG. 3 is a schematic diagram of injection cylinder 355 of injector 270. Hopper 260 feeds the pellets into injector barrel 356 toward the back of helical screw 310. As helical screw 310 turns the pellets move forward to shot chamber 320. As the pellets move through injection chamber 320, they are heated by the shear action created by the turning of helical screw 310 and heater band 350. Helical screw 310 also mixes the materials as the binder melts. A viscous molten material is created containing fiber and material fiber encapsulated by liquid binder.

The pellets must be heated until the binder has melted, but not to the point that the fibers of the fiber material melt. The heating elements create separate zones which increase the temperature of the pellets to a pre-determined temperature in stages. The number of zones can vary dependent on the injection barrel construction chosen to carry out the method. The injector barrel of the preferred embodiment heats the pellets to a maximum temperature of approximately 450° F. by arrival at shot chamber 320. The initial zone, (zone 1 in FIG. 3) is maintained at a regulated process temperature of approximately 200° F. Each heat zone increases the temperature of the pellets at predetermined temperature intervals until the temperature at the nozzle 345 of shot chamber 320 is maximum of approximately 450° F. For example, in one preferred embodiment, zone 1 is maintained at 200°. Zone 2 is maintained at 267°, zone 3 is maintained at 335°, and zone 4 is maintained at 400°.

When a pre-determined amount of molten material is present in shot chamber 320, nozzle gate 340 is opened and helical screw 310 is axially advanced in the injection barrel by a hydraulic ram attached to the screw base (not shown). As helical screw 310 moves forward, the molten material present in shot chamber 320 (known as a metered shot) is forced through nozzle 345 into the cavity mold.

Nozzle 345 used in the preferred embodiment of the invention process is a custom nozzle. Traditional nozzle orifice sizes are typically in the range of ¼″ to ⅛″ in diameter. However, since the molten material being injected is of a higher viscosity, the diameter of a prior art nozzle orifice creates superheating due to shear forces. Super heating and high pressure injection techniques tend to melt and fuse a certain percentage of fibers thereby weakening the final production part. To prevent the superheating, the diameter of nozzle 345 has been increased in the current invention to approximately ⅜″ to 1″. The preferred nozzle 345 orifice diameter is ½″. In practice, the nozzle orifice must be sized to prevent the molten material from being heated above 450° F. In another preferred embodiment the temperature of the nozzle is monitored to regulate the injection pressure in order to maintain a nozzle temperature below 450° F.

In the prior art, the mold is completely closed prior to the injection of molten material. However, in the current invention, cavity mold 280 is not closed completely prior to the injection of the melted polymer. Instead the cavity mold is only partially closed prior to injection.

FIG. 5 demonstrates how the cavity mold is positioned prior to and during the injection of molten material. Mold half 470 is moved toward the stationary half by mold clamp 495. The mold clamp is positioned to within 75% to 95% of its maximum travel to completely close the mold.

Once the cavity mold 280 is partially closed, the heated mixture, in the amount of a metered shot, is then injected into cavity 520 at low pressure. In the preferred embodiment the pressure used to inject the molten material is approximately 50 to 300 psi through manifold 540. The metered shot is calculated to be 105% to 125% higher in volume than the volume of cavity 520. Injecting the metered shot into the cavity results in “over filling” the cavity with molten material. The low pressure of the injected material allows the nozzle gate to effectively seal the mold cavity and isolate it from the shot chamber. Isolation of the shot chamber aids in embodiments where very high compressive force is used to close the mold.

Once cavity mold 280 is overfilled it closed completely by mold clamp 495. In the prior art, molten material would be squeezed out of the mold as it was closed resulting in low or zero compression during formation of the part. However, due to the design of cavity mold 280 and the novel tortuous path, no molten material escapes during the closing of cavity mold 280. Instead, the closing of cavity mold 280 increases the formation pressure on the molten material within cavity mold cavity 520.

Mold clamp 495 in the preferred embodiment exerts approximately 2000 pounds per square inch on the mold during the closure procedure. However, in other alternate embodiments compression forces of up to 10,000 pounds per square inch can be utilized with beneficial results on the compressive strength of the part. In the preferred embodiment the pressure exerted by mold clamp 495 is between 1600 and 1800 pounds per square inch.

High compressive forces exerted by the mold clamp have a tendency to elevate the temperature of the molten material above 450° F. To prevent melting of the fibers, rapid cooling of the part during the compression of the mold is required. Rapid cooling is achieved in the preferred embodiment by the use of a high volume water jacket within the cavity mold which provides a path for circulation of chilled coolant. In the preferred embodiment, the cavity mold halves 460 and 470 have been cored 530 to allow coolant to circulate at a rate of five (5) gallons per minute. The coolant is maintained at a temperature of approximately 35-50° F. during the cooling stage.

After cavity mold 280 has been closed completely by clamp 495, the part and the cavity mold are allowed to cool to a temperature below 100° F. At or around 100° F. the part has gained a sufficient stable form to allow for handling without deformation.

After the cavity mold and the part have cooled, mold half 470 is retracted by mold clamp 495 and the part is ejected by ejection pins.

FIG. 5 also depicts the structure of the cavity mold of a preferred embodiment of the invention. Platen 480, platen 490 and cavity mold clamp 495 are also shown. Platen 480 includes receiver cavity 542 in which injector cylinder 355 is seated. Manifold 540 forms an opening in platen 480 to distribute plastic from shot chamber 320 into cavity mold half 460. Manifold 540 is directly adjacent to nozzle gate 340, nozzle 345 and shot chamber 320. The nozzle gate is activated by a hydraulic cylinder (not shown) attached to the nozzle gate through slot 346 in platen 480.

Cavity mold half 460 is bolted to platen 480. Cavity mold half 460 includes water jacket coring 530 to allow coolant to be introduced into the cavity mold during use. Cavity mold half 460 also includes duct chambers 535 which align with manifold 540 to allow injection of plastic into cavity 520. Cavity mold half 460 includes receiving channels 537 which form part of the tortuous seal of the preferred embodiment of the invention.

Cavity mold half 470 includes channel extensions 539 which fit into receiver channels 537. In the preferred embodiment, the clearance between receiver channels 537 and channel extensions 539 is approximately 2/10000 inch. However, tolerances of the order of ⅛ inch can be tolerated depending on the viscosity of the injected plastic and the geometry of the tortuous path seal employed. In the preferred embodiment, receiver channels 537 form a continuous path ring around cavity 520. Also in the preferred embodiment, channel extensions 539 form a continuous raised rings around cavity 520 and which fit completely into receiver channels 537.

In the preferred embodiment, the height of channel extensions 539 is approximately ½ inch plus or minus 2/10000 inch. In the preferred embodiment, the depth of channel extensions 539 is also approximately ½ inch plus or minus 2/10000 inch. Similarly, the width of receiver channels 537, 605 and 610 in the preferred embodiment is ½ inch plus or minus 2/10000 and the width of receiver channels 537 is also ½ inch plus or minus 2/10000.

Cavity mold half 470 further comprises water jacket coring 532 for the entrance of cooling water into the cavity mold. Cavity mold half 470 also includes release pin throughhole 543. Cavity mold half 470 in the preferred embodiment is bolted to platen 490 which in turn is bolted to piston rods 570. Piston rods 570 fit within mating hydraulic cylinders within cavity mold clamp 495. Release pin 546 is a rigid cylindrical rod fixed to the base of cavity mold clamp 495 and extending through release pin throughhole 543 in cavity mold half 470. When piston rod 570 is retracted, release pin 546 extends through release pin throughhole 543 into cavity mold 520.

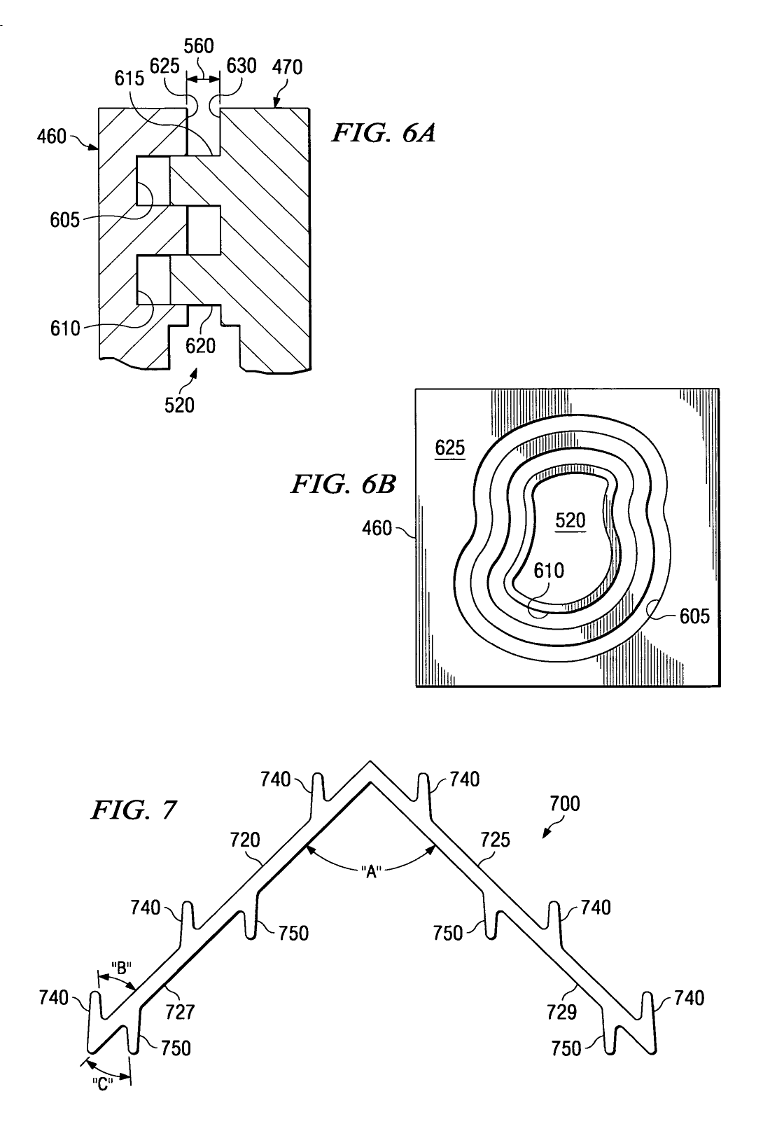

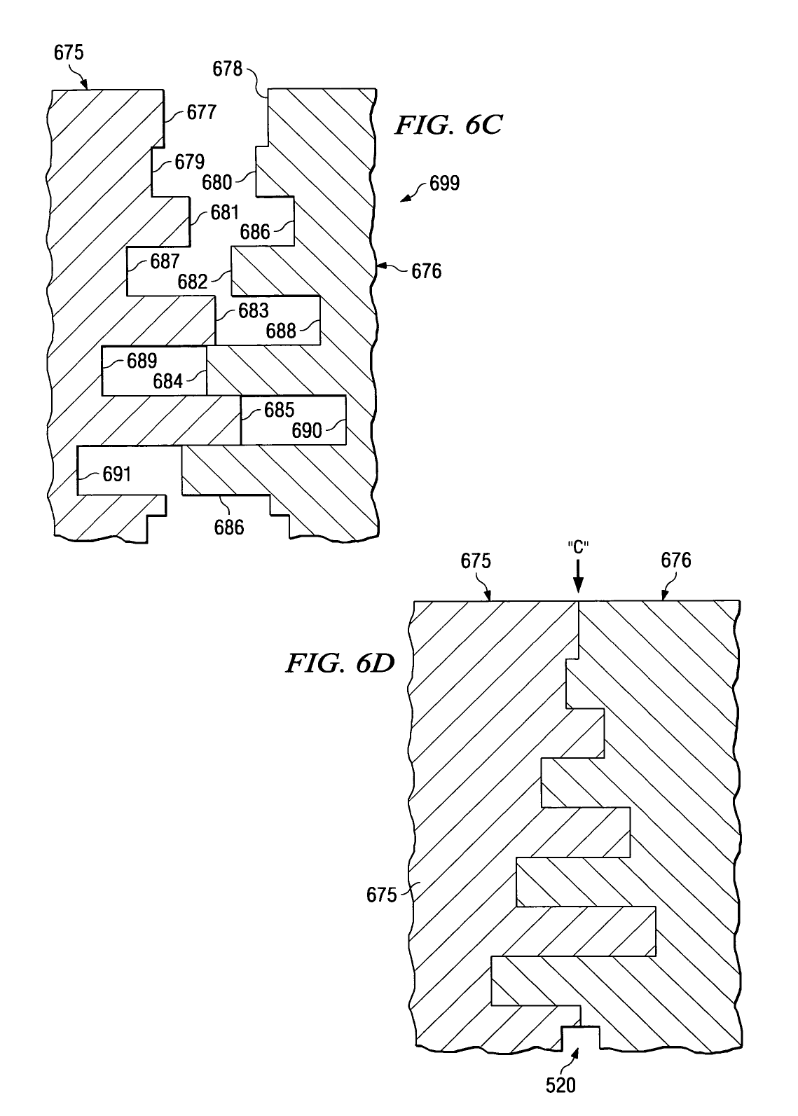

An alternate embodiment of the tortuous path seal in the cavity mold is shown in FIG. 6A. In FIG. 6A, cavity mold halves 460 and 470 are shown in a partially engaged position. Cavity mold half 460 includes mold face 625 and two receiver channels 605 and 610. Cavity mold half 470 includes a cavity mold half 630 and two channel extensions 615 and 620. Channel extension 615 fits into receiver channel 605 while channel extension 620 fits into receiver channel 610.

In the preferred embodiment, the width of channel extensions 615 and 620 is approximately ½ inch plus or minus 2/10000 inch. In the preferred embodiment, the depth of channel extensions 615 and 620 is also approximately ½ inch plus or minus 2/10000 inch. Similarly, the width of receiver channels 605 and 610 in the preferred embodiment is ½ inch plus or minus 2/10000 and the depth of receiver channels 650 and 610 is also ½ inch plus or minus 2/10000. One skilled in the art will recognize that the height of the channel extensions and the depth of the receiver channels is dependent on the pressure to be used to compress the mold halves. Substantially high pressures above 2000 psi will require larger extensions and deeper channels to prevent the escape of molten material.

Cavity mold halves 460 and 470 are shown in FIG. 6A to be in a partially engaged position. In the partially engaged position, the channel extensions extend into the receiver channels sufficiently to form a seal between cavity mold 520 and the exterior of the cavity mold. A gap 560 is formed between cavity mold face 625 and 630 when the cavity mold halves are in partially engaged position. The width of gap 560 is dependent on the travel of cavity mold half 470 during extension of hydraulic pistons 570. In the preferred embodiment, gap 560 is approximately 10% of the distance of the maximum travel of piston rods 570. It will be appreciated by those of skill in the art that the length of the tortuous path seal created by the mating of the cavity mold halves increases as the mold is closed.

Moving to FIG. 6B, the plan view of cavity mold half 460 is shown. Cavity mold half 460 includes mold cavity 520 and receiver channels 605 and 610 and cavity mold face 625. From this figure can be seen that the receiver channels extend around mold cavity 520 and reflect the shape of the cavity. Those skilled in the art will understand that the shape of mold cavity 520 can vary and that the geometry of the receiver channels must necessarily also vary with the shape of the parameter of the mold cavity. Those skilled in the art will also understand that channel extensions 615 and 620 also follow the parameter of mold cavity 520 in mold cavity half 470 and will fit within the receiver channels when mold cavity 460 and mold cavity 470 are partially and completely closed.

Referring now to FIGS. 6C and 6D yet another preferred embodiment of the cavity mold and tortuous path seal can be examined as 699. FIG. 6C shows mold halves 675 and 676 in a partially closed position. FIG. 6D shows mold halves 675 and 676 in a fully closed position.

Cavity mold 699 includes channel extensions and receiver channels which vary in height and depth, respectively as measured from the cavity 520 to the exterior of the mold. Both mold halves 675 and 676 have mold faces 677 and 678 respectively. Mold half 675 has three channel extensions, 681, 683 and 685 respectively. The three channel extensions fit into receiver channels 686, 688 and 690 in mold half 676. Mold half 676 has four channel extensions 680, 682, 684 and 686 which fit into receiver channels 679, 687, 689 and 691 in mold half 675. The width of each receiver channel and channel extension is approximately ½ inch. As measured from the center of the mold (designated as “C” in FIG. 6D) the height of channel extension 686 is approximately ⅞ inch, the corresponding depth of receiver channel 691 is approximately ⅞ inch, the height of channel extension 685 is approximately ¾ inch, the corresponding depth of channel extension 690 is approximately ¾ inch. The height of channel extension 684 is approximately ⅝ inch the corresponding depth of channel extension 689 is also approximately ⅝ inch. The height of channel extension 683 is approximately ½ inch, the corresponding depth of receiver channel 688 is approximately ½ inch the height of channel extension 682 is approximately ⅜ inch the corresponding depth of receiver channel 687 is approximately ¾ inch. The height of channel extension 681 is approximately ¼ inch the corresponding depth of receiver channel 686 is approximately ¼ inch. The height of channel extension 680 is approximately ⅛ inch the corresponding depth of receiver channel 679 is approximately ⅛ inch. In the preferred embodiment engineering tolerances of 2/10000 inch are held on the dimensions.

In operation the channel extensions and receiver channels of 699 are arranged in such a way that as the pressure increases in cavity 520 due to the compression of the mold halves by the mold clamp, the robustness of the tortuous path seal increases by the additional interlocking of receiver channels and channel extensions as the mold halves are closed. It has been discovered that extremely high mold pressures can be achieved through use of geometries of alternating receiver channels and channel extensions of decreasing height and depth respectively.

The compressive strength for parts produced from the described process is between 3000 and 5000 pounds per square inch.

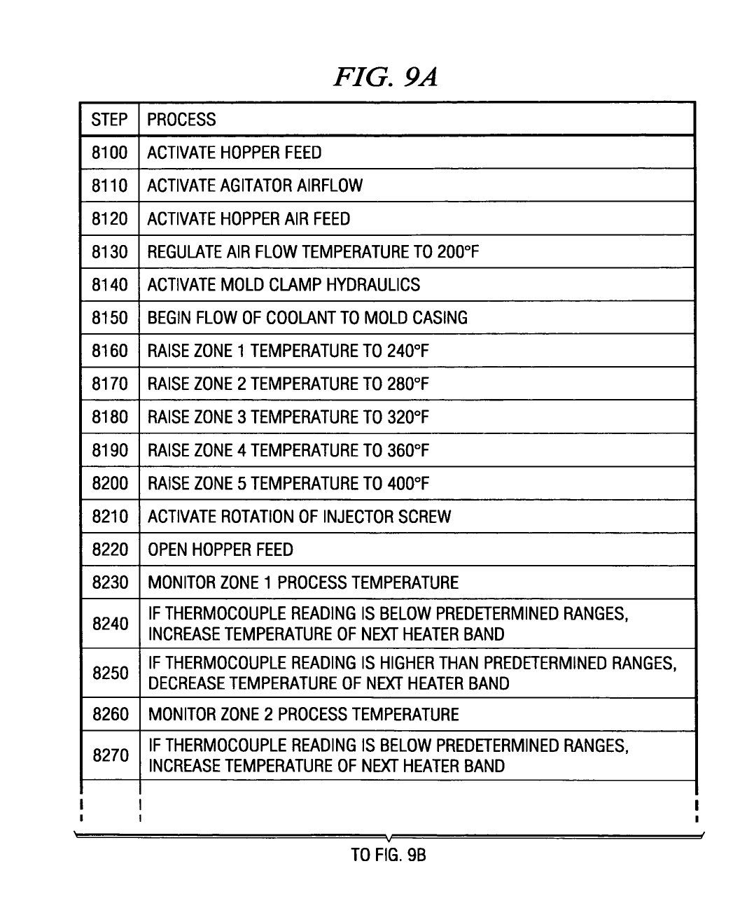

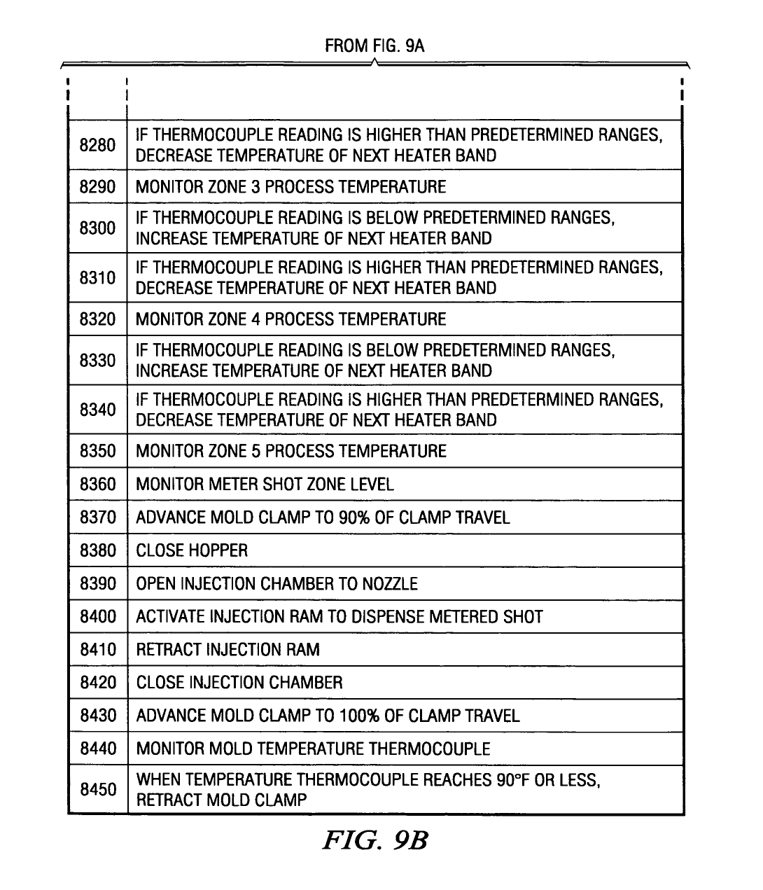

The controller of the preferred embodiment is programmed to carry out some of the steps of the process of the invention automatically. FIG. 9 is a listing of linear pseudo code programming of the controller.

The hopper feed is activated at step 8100. An agitator air flow is also activated at step 8110.

The air flow to the hopper is activated in step 8120. The temperature of the hopper airflow is regulated to approximately 200° F.

The cavity mold clamp hydraulics are activated in step 8140. In step 8150, the coolant flow to the cavity mold casing is started.

At step 8160, the controller raises the temperature of the heating elements in zone 1 to 240°. At step 8170, the controller raises the temperature of the heating elements in zone 2 to 280°. At step 8180, the controller raises the temperature of the heating elements in zone 3 to 320°. At step 8190, the controller raises the temperature of the heating elements in zone to 360°. At step 8200, the controller raises the temperature of the heater band in zone 5 to 400°.

When the heating bands have reached the pre-determined level, the injector helical screw is activated in step 8210 and the hopper is opened in step 8220.

As the pellets move through the injection chamber the process temperature is monitored to verify that the temperature of the process is in accordance with the specifications. When the pellets are in zone 1, the temperature is monitored in step 8230. If the temperature is below the pre-determined range, the temperature for the next heater zone is increased in step 8240. If the temperature of the process is higher than the pre-determined range, the temperature of the next zone is decreased in step 8250.

When the pellets are in zone 2, the temperature is monitored in step 8260. If the temperature is below the pre-determined range, the temperature for the next heater zone is increased in step 8270. If the temperature of the process is higher than the pre-determined range, the temperature of the next zone is decreased in step 8280.

When the pellets are in zone 3, the temperature is monitored in step 8290. If the temperature is below the pre-determined range, the temperature for the next heater zone is increased in step 8300. If the temperature of the process is higher than the pre-determined range, the temperature of the next zone is decreased in step 8310.

When the pellets are in zone 4, the temperature is monitored in step 8320. If the temperature is below the pre-determined range, the temperature for the next heater zone is increased in step 8330. If the temperature of the process is higher than the pre-determined range, the temperature of the next zone is decreased in step 8340.

When the pellets are in zone 5, the temperature is monitored in step 8355.

The amount of material deposited into the shot chamber is monitored at step 8360. At step 8370 the cavity mold clamp is advanced to 90% of its travel. At step 8380, the hopper is closed. The injection chamber is opened to the nozzle in step 8390. The injection ram is then activated and moves the helical screw forward to dispense the metered shot into the cavity mold cavity in step 8400.

The injection ram is retracted in step 8410 and the injection chamber closed in 8420.

In step 8430, the cavity mold clamp then advances 100% of its travel.

The temperature of the product in the cavity mold is monitored through a thermocouple in step 8440 and maintained at a temperature below 450° F. When the temperature reaches approximately 90° F. or less, in step 8450, the cavity mold clamp retracts thereby releasing the product from the cavity mold cavity.

FIG. 7 depicts a plan view of a preferred embodiment of a part that is manufactured by the process of the invention. The part is a corner post such as that incorporate into packaging for large appliances.

Corner post 700 includes two exterior sides 720 and 725 and two interior sides 727 and 729. The interior sides are separated by an angle “A” which in the preferred embodiment is approximately 90 degrees. This angle may vary depending on the intended use of the corner post. A plurality of shock arresting exterior “fins” 740, are integrally formed on exterior surfaces 720 and 725. Similarly, a plurality of interior shock arresting fins 750 are integrally formed on interior surfaces 727 and 729. Each exterior shock arresting fin 740 form an acute angle B with the exterior surfaces. In the preferred embodiment, acute angle “B” is approximately 45 degrees, however, this angle may vary. In an alternate preferred embodiment, angle B may be an obtuse angle of approximately 135 degrees. Each interior shock arresting fin 750 forms an angle “C” with the interior surfaces. In the preferred embodiment, angle C is an acute angle of approximately 45 degrees. In an alternate embodiment, angle C may be an obtuse angle of approximately 135 degrees.

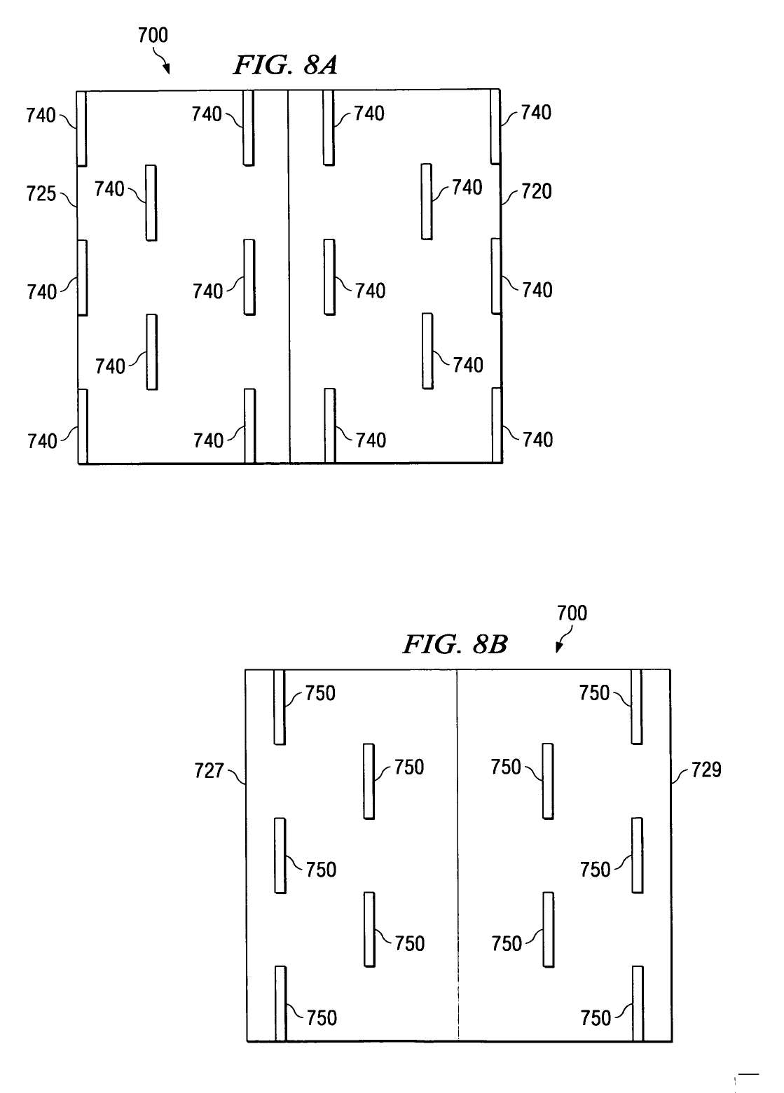

Moving now to FIGS. 8A and 8B, an elevation view of the exterior and interior of corner post 700 are depicted. Exterior shock arresting fins 740 are disbursed in an angular pattern across exterior faces 725 and 720 of corner post 700. As shown in FIG. 8B, interior shock arresting fins 750 are also disposed in an angular pattern of interior surfaces 727 and 729 and corner post 700. In the preferred embodiment, the height of each interior shock arresting fin 750 is approximately ⅓ inch as measured from the face of the interior surfaces outward. The width of each interior shock arresting fin 750 as measured across the face of each interior surface is approximately ⅛ inch, but can range from between 1/10 inch to 1 inch, depending on the application in which the corner post is used. The length of each interior shock arresting fin 750 is approximately 3.5 inches in the preferred embodiment, but can range from 1 inch to the complete length of the corner post as measured from top to bottom in the figure.

### EXAMPLE 1

The raw materials for the final product are waste poly propylene carpet having a glue resin backing of polyolefin and polypropylene agricultural film. Approximately 180 pounds of carpet was cut by hand into 1″ or 2″ pieces. The pieces are fed into a laboratory size Cumberland grinder at a rate of 5 to 10 pounds per hour. Grinding was continued for approximately one minute or until a particle size of between ⅛″ and ¼″ was reached. Particles exit a ¼″ screen from the grinder. There were individual fiber lengths that may be longer than 1/4″ and some particle sizes may be less that ⅛″. The temperature of the material exiting the grinder was approximately 125° F.

Approximately 120 pounds agricultural film was cut by hand into 1″ or 2″ pieces. The pieces were then fed into a laboratory-size Cumberland grinder. The grinding was done using a ¼″ screen to produce an average particle size of between ⅛″ and ¼″. The material was ground a short period of time, approximately 1 minute. The exit rate from the grinder was approximately 5 to 10 pounds per hour. The temperature of the material exiting the grinder was slightly elevated due to the shear energy.

The ground carpet and agricultural film were blended in blender at a ratio of 60/40 of carpet to agricultural film by weight. The weight of the mixture after blending was about 300 pounds.

Once the materials were blended, they were pelletized in a pellet mill. A California Pellet Mill was used. The feed rate into the pellet mill was approximately 20 pounds per hour. Blending time was approximately 10 seconds. The pellet size created was approximately ⅛″ in diameter and length of 3/16″. The pellitization rate was approximately 20 pounds per hour.

The pellets were then sent to the injection machine. About 20 pounds of pellets were fed into the hopper. In order to remove the surface moisture, the pellets were held in the hopper for approximately 1 hour while hot dry air, at a temperature of approximately 200° F., was fed into the bottom of the hopper. The pellets rose to a temperature of approximately 200° F.

After being heated for approximately 1 hour in the hopper, the pellets were fed into the injection chamber. The feed temperature was approximately 200° F. The injection machine used was an 84 ton Toshiba injector. In this example, the pellets were increased in temperature from the feed temperature of 200° F. to 400° F. exit temperature. Change in temperature was partially accomplished by shear forces. The remaining increase in temperature was accomplished by heating elements that create four different heat zones. Each zone increased the temperature by about 50° F. The amount of time the pellets were in the injection machine prior to injection was about 2 to 3 minutes.

Approximately 110% of the cavity mold volume of molten material was collected in the shot chamber, the cavity mold clamp was activated and advanced to approximately 90% of its travel range, thereby partially closing the cavity mold and engaging the channel extensions and receiver channels of the cavity mold. The shot size of approximately ½ pound of molten material was then injected into the cavity mold with the injection nozzle. The nozzle was a custom nozzle in which the orifice diameter has been increased. The nozzle orifice diameter was increased from ⅛″ to ¼″.

The pressure in the cavity mold prior to closing was around 200 to 300 psi. The cavity mold was then closed completely by activating the mold clamp to 100% of its travel thus increasing the pressure to approximately 2000 psi. The time to inject the material was approximately 10 to 15 seconds.

Coolant was then circulated through the cavity mold to decrease the temperature of the material within the cavity mold cavity to approximately 90° F.

Once the temperature of the material in the cavity was decreased to 90° F., the cavity mold was opened and the finished part removed.

The cross sectional area of the part produced by this process was approximately 0.9375 in² and withstood a compressive force of approximately 4000 pounds or resulting compressive strength of 4267 pounds per square inch.

### EXAMPLE 2

In this next example, remnants from diaper production were added to the carpet and agricultural film. The carpet and agricultural film were ground as discussed in Example 1. Further 80 pounds of diapers were cut by hand into 1″ to 2″ pieces that were then fed into the grinder. The material was ground at a rate of 5 to 10 pounds per hour. The grinder used was a Cumberland grinder. The grinder was fitted with a ¼″ screen and produced an average particle size of between ⅛″ and ¼″ in length. The material was ground for approximately 1 minute. The temperature of the material exiting the grinder was slightly elevated due to the shear energy during the grinding.

The ground diapers, ground carpet, and ground agricultural film were fed simultaneously into a blender. The ratio of diapers to agricultural film was 40% diapers, 40% carpet, and 20% agricultural film by weight. The material included 80 pounds of ground diaper, 80 pounds of ground carpet, and 40 pounds of ground agricultural film. The weight upon exit from the blending was about 200 pounds.

After the diapers, carpet, and agricultural film were blended, they were pellitized. The feed rate into the pellet mill of the blended mixture was 20 pounds per hour. A California Pellet Mill was used to create the pellets. The approximate time the blended mixture stays in the mill was 10 seconds. The pellet size created was approximately ⅛″ in diameter and length of 3/16″. The pellitization rate was approximately 20 pounds per hour.

The pellets were then sent to the injection machine. About 20 pounds of pellets were fed into the hopper. In order to remove the surface moisture, the pellets were held in the hopper for approximately 1 hour while hot dry air, at a temperature of approximately 200° F., was fed into the bottom of the hopper. The pellets rose to a temperature of approximately 200° F.

After being heated for approximately 1 hour in the hopper, the pellets were fed into the injection chamber. The feed temperature was approximately 200° F. The injection machine used was an 84 ton Toshiba injector. In this example, the pellets were increased in temperature from the feed temperature of 200° F. to 400° F. exit temperature. Change in temperature was partially accomplished by shear forces. The remaining increase in temperature was accomplished by heating elements that create four different heat zones. Each zone increased the temperature by about 50° F. The amount of time the pellets were in the injection machine prior to injection was about 2 to 3 minutes.

Approximately 110% of the cavity mold volume of molten material was collected in the shot chamber, the cavity mold clamp was activated and advanced to approximately 90% of its travel range, thereby partially closing the cavity mold and engaging the channel extensions and receiver channels of the cavity mold. The shot size of approximately 1 pound of molten material was then injected into the cavity mold with the injection nozzle. The nozzle orifice diameter was about ¼″.

The pressure in the cavity mold prior to closing was around 200 to 300 psi. The cavity mold was then closed completely by activating the mold clamp to 100% of its travel thus increasing the pressure to approximately 2000 psi. The time to inject the material was approximately 10 to 15 seconds.

Coolant was then circulated through the cavity mold to decrease the temperature of the material within the cavity mold cavity to approximately 90° F.

Once the temperature of the material in the cavity was decreased to 90° F., the cavity mold was opened and the finished part removed.

The cross sectional area of the part made from this process was approximately 0.9375 in² and withstood a compressive force of approximately 3000 pounds for a resulting compressive strength of approximately 3200 pounds per square inch.

### EXAMPLE 3

In this example, the materials are post consumer plastics, specifically plastic bottles manufactured from polyethylene (HDPE) and polyethylene terephthalate (PET), as the raw materials.

20 pounds of PET was cut into 1″ or 2″ pieces and then fed into a

Cumberland grinder with a screen size of ¼″. The PET is ground at a rate of 5 to 10 pounds per hour. The particles upon leaving the grinder were an average of between ⅛″ and ¼″ in length.

About 30 pounds of HDPE was cut into 1″ or 2″ pieces. The HDPE was fed into a grinder at the rate of approximately 5 to 10 pounds per hour. A ¼″ screen on the grinder produces an average particle size of between ⅛″ and ¼″ in length in approximately 1 minute. The temperature of the material exiting the grinder was approximately 200° F.

The ground PET and HDPE were fed into a blender at a ratio of 40/60 of PET to HDPE by weight. The blending pieces formed approximately 50 pounds of PET and HDPE mixture.

The blended mixture was pelletized in a pellet mill at a feed rate of 20 pounds per hour. A California Pellet Mill was used to create the pellets. The approximate amount of time the blended mixture stayed in the mill is approximately 10 seconds. The pellet size created was approximately ⅛″ in diameter and length of 3/16″.

The PET and HDPE were fed simultaneously into a blender. The ratio of HDPE to PET was approximately 60%/40% by weight. The feed includes 30 pounds of HDPE and 20 pounds of ground PET. The exit from the blending the combination weighed about 50 pounds.

The pellets were fed directly into the injection chamber without drying or preheating. The injection machine used was an 84 ton Toshiba injector. In this example, the pellets were increased in temperature from the feed temperature of 200° F. to 400° F. exit temperature. Each of four zones increased the temperature by 50° F. The amount of time the pellets were in the injection machine prior to injection was about 2 to 3 minutes.

Approximately 125% of the cavity mold volume of molten material was collected in the shot chamber, the cavity mold clamp was activated and advanced to approximately 75% of its travel range, thereby partially closing the cavity mold and engaging the channel extensions and receiver channels of the cavity mold. The shot size of approximately ¾ pound of molten material was then injected into the cavity mold with the injection nozzle. The nozzle orifice diameter was approximately ¼″.

The pressure in the cavity mold prior to closing was around 200 to 300 psi. The cavity mold was then closed completely by activating the mold clamp to 100% of its travel thus increasing the pressure to approximately 3000 psi. The time to inject the material was approximately 10 to 15 seconds.

Coolant was then circulated through the cavity mold to decrease the temperature of the material within the cavity mold cavity to approximately 90° F.

Once the temperature of the material in the cavity was decreased to 90° F., the cavity mold was opened and the finished part removed.

The compressive strength of the part formed was approximately 3500 psi.

The embodiments have been described in detail with particular reference to certain preferred embodiments thereof, but it will be understood that variations and modifications can be effected within the scope of the embodiments, especially to those skilled in the art. Specifically, the process, as described can be conducted on a continuous basis or can be conducted in steps where the results for the different step is stored until the process is resumed at a different time or location.

1. A method of forming a high compressive strength part from recycled waste comprising the steps of:
selecting a fiber material;
selecting a binder;
grinding the fiber material and the binder;
blending the fiber material and the binder in a predetermined ratio into a homogeneous mixture;
heating and mixing the homogenous mixture until the binder melts forming a molten mixture;
providing a cavity mold comprising a cavity having a volume and surrounded by a partially engagable tortuous path seal;
partially engaging the partially engagable tortuous path seal;
injecting the molten mixture into the cavity at a predetermined volume above the volume of the cavity;
compressing the cavity mold by a predetermined force to fully engage the partially engagable tortuous path seal; and,
cooling the cavity mold to form a high compressive strength part in the cavity.

2. The method of claim 1 wherein the fiber material is chosen from the group of unwashed carpet, washed carpet, unused diapers and diaper remnants.

3. The method of claim 2 wherein the predetermined ratio is 80% fiber material, comprised of 40% unwashed carpet and 40% diaper remnants and 20% binder.

4. The method of claim 1 wherein the fiber material is chosen from the group of fibrous polypropylene, fibrous polyethylene, ethyl vinyl acetate and polyvinyl chloride.

5. The method of claim 1 wherein the binder is chosen from the group of washed agricultural film, unwashed agricultural film, recyclable plastic bottles.

6. The method of claim 1 wherein the binder is polyethylene.

7. The method of claim 1 wherein the predetermined ratio is approximately 60% fiber material to 40% binder.

8. The method of claim 1 wherein the step of heating and mixing further comprises heating the homogeneous mixture in a plurality of zones and mixing the homogenous mixture with a helical screw.

9. The method of claim 8 wherein the step of heating includes heating the homogeneous mixture to a temperature below 450° F.

10. The method of claim 1 wherein the step of providing a cavity mold further comprises providing a cavity mold comprising a cavity having a volume surrounded by a partially engagable tortuous path seal further comprising an interlocking plurality of channel extensions and receiver channels.

11. The method of claim 10 further comprising the step of providing a plurality of channel extensions of varying heights and corresponding receiver channels of varying depths.

12. The method of claim 1 wherein the step of partially engaging the partially engagable tortuous path seal comprises closing the cavity mold to within a predetermined percentage of mold travel.

13. The method of claim 12 wherein the predetermined percentage of mold travel is between 75% and 95%.

14. The method of claim 1 wherein the step of injecting the molten mixture further comprises injecting the molten mixture at low pressure.

15. The method of claim 1 wherein the predetermined volume is in the range of 110% of the cavity volume to 130% of the cavity volume.

16. The method of claim 1 wherein the predetermined force is between 1600 psi and 10000 psi.

17. An injection mold for the formation of high compression strength plastic parts comprising:
a pair of mold halves comprising a first mold half and a second mold half that when assembled form an injection cavity;
the first mold half further comprising a receiver channel following a perimeter of the cavity;
the second mold half further comprising a channel extension following the perimeter of the cavity;
and wherein the channel extension fits within the receiver channel to form a tortuous path seal to prevent escape of a molten material from the cavity during an injection molding process of high compression strength plastic parts.

18. The injection mold of claim 17 wherein:
the first mold half further comprises a plurality of receiver channels concentrically arranged around a perimeter of the cavity;
the second mold half further comprises a plurality of channel extensions concentrically arranged around the perimeter of the cavity; and,
wherein the plurality of channel extensions fit within the plurality of receiver channels to form a tortuous path seal to prevent escape of a molten material from the cavity during an injection molding process of high compression strength plastic parts.

19. The injection mold of claim 18 wherein the plurality of channel extensions is of varying height and the plurality of receiver channels is of varying depth.

20. The injection mold of claim 19 wherein the channel extension of the greatest height from the plurality of channel extensions is adapted to engage the receiver channel of the greatest depth form the plurality of receiver channels when the first mold half and the second mold half are closed to a predetermined percentage.

21. The method of claim 20 wherein the predetermined percentage is between 75% and 95%.

22. The injection mold of claim 17 wherein the receiver channel is adapted to fully engage the channel extension where the first mold half and the second mold half are closed to a predetermined percentage.

23. The method of claim 22 wherein the predetermined percentage is between 75% and 95%.

24. An injection mold for the formation of parts from a fiber material and molten binder comprising:
a mold body comprising at least a first mold half a second mold half and a mold cavity;
the mold body further comprising a tortuous path seal means between the first mold half and the second mold half, for preventing escape of the fiber material and molten binder from the mold cavity during assembly of the first mold half and the second mold half during an injection molding process; and,
wherein the tortuous path seal means is increased in length as the first mold half is assembled with the second mold half thereby increasing the pressure of the fibrous fiber material and molten binder within the cavity during the injection molding process.

25. The injection mold of claim 24 wherein the tortuous seal path means further comprises a first alternating set of channel extensions and receiver channels on the first mold half;
a second alternating set of channel extensions and receiver channels on the second mold half; and,
wherein the first alternating set is adapted to mate with the second alternating set.

26. The injection mold of claim 25 wherein the height of the channel extensions and the depth of the receiver channels decreases as measured from the mold cavity to the exterior of the mold body.

27. A high compressive strength plastic part made by the process of:
selecting and grinding a fiber material and a binder;
blending the fiber material and binder at a predetermined ratio;
heating the fiber material and binder to a temperature sufficient to melt the binder but not melt the fiber material into a molten material;
providing an injection mold having a tortuous path seal means around the perimeter of a mold cavity to prevent escape of the molten material from the mold cavity;
closing the injection mold to within between 75% and 95% of closure,
injecting the molten material into the mold cavity;
closing the mold to 100% of closure; and,
allowing the molten material to cool thereby forming the high compressive strength plastic part.

28. The part of claim 27 further comprising:
an angular channel having an exterior surface and an interior surface;
a plurality of exterior fins angularly disposed on the exterior surface; and,
a plurality of internal fins angularly disposed on the interior surface.

29. The part of claim 27 having a compressive strength of between about 3000 psi and 5000 psi.

30. The part of claim 27 wherein the step of closing the mold further comprises
applying a predetermined compressive force to the injection mold.

31. The part of claim 30 wherein the predetermined force is between about 1800 psi and 2000 psi.

32. The part of claim 30 wherein the predetermined force is between about 1600 psi and 10000 psi.

33. The part of claim 27 wherein the predetermined ratio is about 60% fiber material to about 40% binder.

34. The part of claim 27 wherein the fiber material comprises carpet and the binder comprises agricultural film.

35. A corner post for packing large appliances comprising:
a first planar member;
a second planar member;
the first and second planar members integrally joined along a seam at an angle of approximately 90°;
a first plurality of radial fins integrally joined with and projecting from the first planar member;
a second plurality of radial fins integrally joined with and projecting from the second planar member;
the first planar member, second planar member, first plurality of radial fins and second plurality of radial fins formed simultaneously in an injection cavity of a compressive injection mold means for pressurizing molten material.
The compressive injection mold means further comprising a tortuous path seal means for containing molten material within the injection cavity during formation of the planar member, second planar member, first plurality of radial fins and second plurality of radial fins.

36. The corner post of claim 35 having a compressive strength of between 3000 psi and 4000 psi.

37. The corner post of claim 35 wherein the planar member, second planar member, first plurality of radial fins and second plurality of radial fins are formed of a molten binder and fibrous fiber material combination.
